(19) United States
(12) Patent Application Publication
(10) Pub. No.: US 2013/0185323 A1
(43) Pub. Date: Jul. 18, 2013

(54) SOCIAL NETWORK SERVICE

(71) Applicant: George Moser, Redwood City, CA (US)

(72) Inventor: George Moser, Redwood City, CA (US)

(21) Appl. No.: 13/351,158

(22) Filed: Jan. 16, 2012

(51) Int. Cl. G06F 17/30

(52) U.S. Cl. 707/769; 707/E17.014

(57) ABSTRACT

A computer-based system for the implementation of a social network service is provided. The system includes a user information database, a groups database and an interests database. A referral generator analyses information stored within the databases to identify common interests between users and/or groups, and prompt users with suggested associations. Interests may be regional in nature, facilitating in-person communications in addition to communications via the social network service.

### FIELD OF THE INVENTION

The invention relates to the field of computer network systems for the creation, administration and propagation of social networks on the Internet.

### BACKGROUND

The most successful social network so far has been Facebook, which has reached a user base of approximately 800 million users, which represents more than 10% of the world population. That is a remarkable achievement, and it makes it very clear how important social connection on the Internet is for humankind.

FIG. 1 shows the basic structure of the prior art Facebook social network, wherein the user 1 signs up with the Facebook System and creates his/her personal Facebook user page 5. The user draws from his previously existing contacts (family, friends and acquaintances) and enters them into his page to populate it. The page 5 is also used to post pictures, news, videos, event notices and other communications.

In light of such a remarkable success, the question comes up: does the world need another social network? Using an analogy, when the founders of Google were trying to launch their new search engine, one of the biggest obstacles they encountered was the perception that previous search engines had already met the needs and wants of Internet users—and cornered the market. They were confronted with the same type of question: does the world need another search engine? Yahoo and other search engines seemed at the time to be doing a very good job. The answer for the Google founders was yes, because they realized that the Internet is such a dynamic field that a better approach or a superior technology can shift user preferences in a dramatic way in a short period of time. No system or technology is entrenched in a permanent way, and things do change in this industry very quickly.

Meanwhile, in many existing social networks, it can be difficult to find local contacts within a user's area. It can also be hard to find new individuals that may have compatible interests, and connect with them. The operation of existing social network sites may also encourage on-line communication, at the expense of real-world interaction between people.

Just like Yahoo was obviously not the last word in search engines, Facebook may not be the last word in social networks. Alternative social network services may engage even a larger potential user base and revenue potential than prior social network systems.

### BRIEF DESCRIPTION OF THE DRAWINGS

FIG. 1 is a schematic block diagram of a prior art social network service.

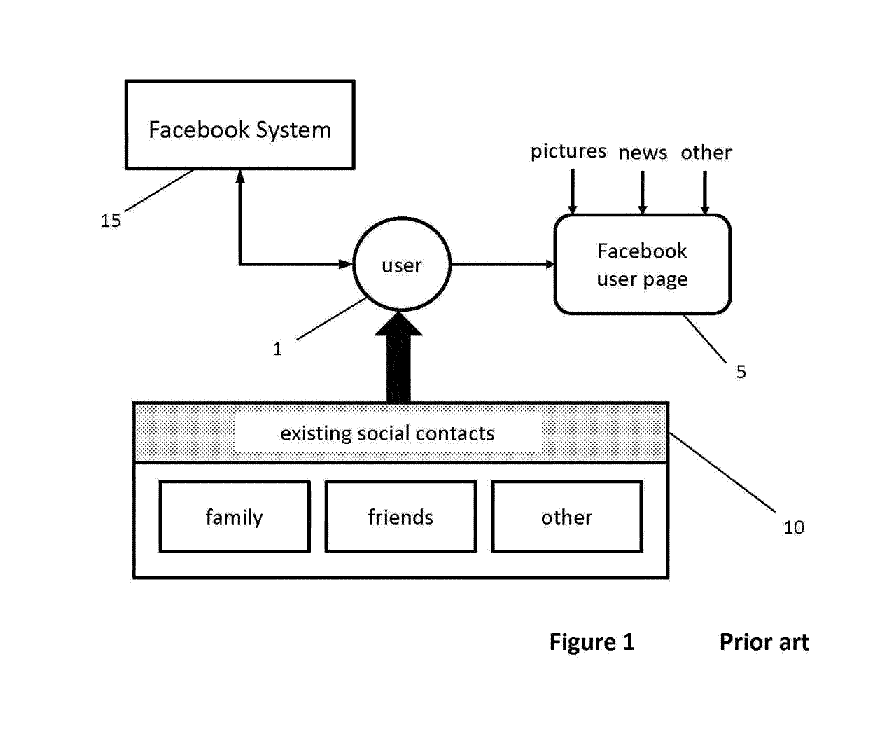

FIG. 2 is a schematic block diagram illustrating a social network service featuring a pool of interests, in accordance with one embodiment of the present disclosure.

FIG. 3 is a schematic block diagram illustrating further operation of a social network service, in accordance with an illustrated embodiment.

FIG. 4 is a schematic block diagram of computer infrastructure for a social network service.

FIG. 5 illustrates an exemplary social network service login user interface.

FIG. 6 illustrates an exemplary social network service account setup user interface.

FIG. 7 illustrates an exemplary social network service home page user interface.

FIG. 8 is an exemplary user interface diagram for yet a further aspect of a social network service user interface.

FIG. 9 is an exemplary user interface diagram for interests search results.

FIG. 10 is an exemplary user interface diagram for a group page.

### DETAILED DESCRIPTION

While this invention is susceptible to embodiment in many different forms, there are described in detail herein several specific embodiments, with the understanding that the present disclosure is to be considered as an exemplification of the principles of the invention and is not intended to limit the invention to the embodiments illustrated.

In accordance with embodiments described herein, it may be desirable to establish social networking services which can include orientation around common interests, encourage new connections between individuals, and/or encourage not just online interaction between individuals, but also real-world interaction. Embodiments may address important major societal trends and meet the needs of humans for relevant social interaction in ways that other systems do not. Embodiments may further help break the social isolation that technology can intensify in modern society, connect people with other people to meet essential human needs and generally do good for humanity.

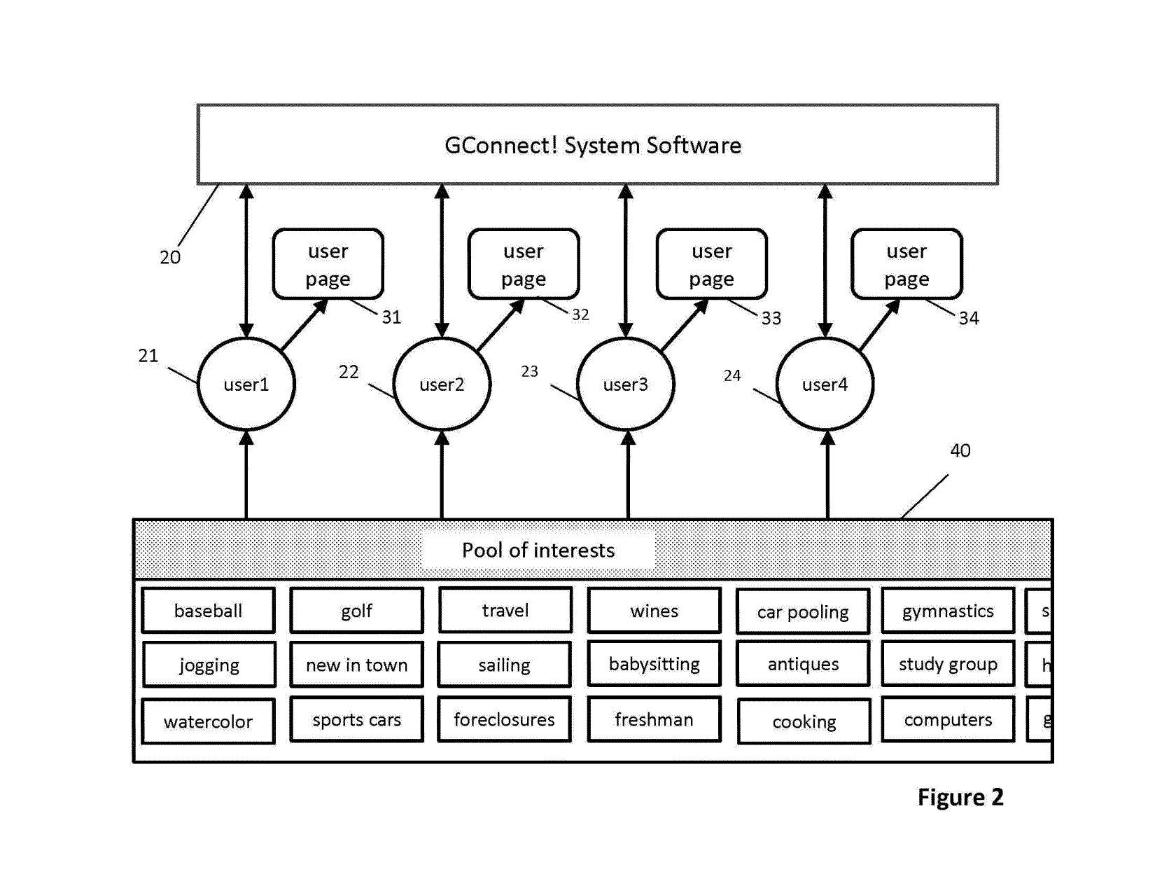

FIG. 2 illustrates an embodiment of a social network service, which for easy reference is sometimes referred to in this disclosure as GConnect! (where the G stands for Global). A plurality of users, such as users 21, 22, 23 and 24, are connected to the G-Connect System Software 20, which allows each of them to easily create a user page such as user pages 31, 32, 33 and 34. The users can then populate their user pages with interests drawn from a pool of interests 40 (as opposed to entering just their previously existing contacts such as family and friends).

The pool of interests is very broad and includes all types of interests, which may be utilitarian (such as finding a baby-sitter in the same neighborhood or town, or finding somebody to car-pool with who lives nearby), hobby-related (golf, wine-collecting, sailing, jogging, cooking, sports cars, painting, gymnastics, etc.), sports-related (spectator or participatory sports of any type), study-related (such as finding a study group for high school or college, or getting to know other freshman or upper classsmen in college), professional networking (such as finding other engineers, lawyers, physicians, pipefitters or mechanics nearby), move-related (such as finding contacts in a new town) or many other types of interests.

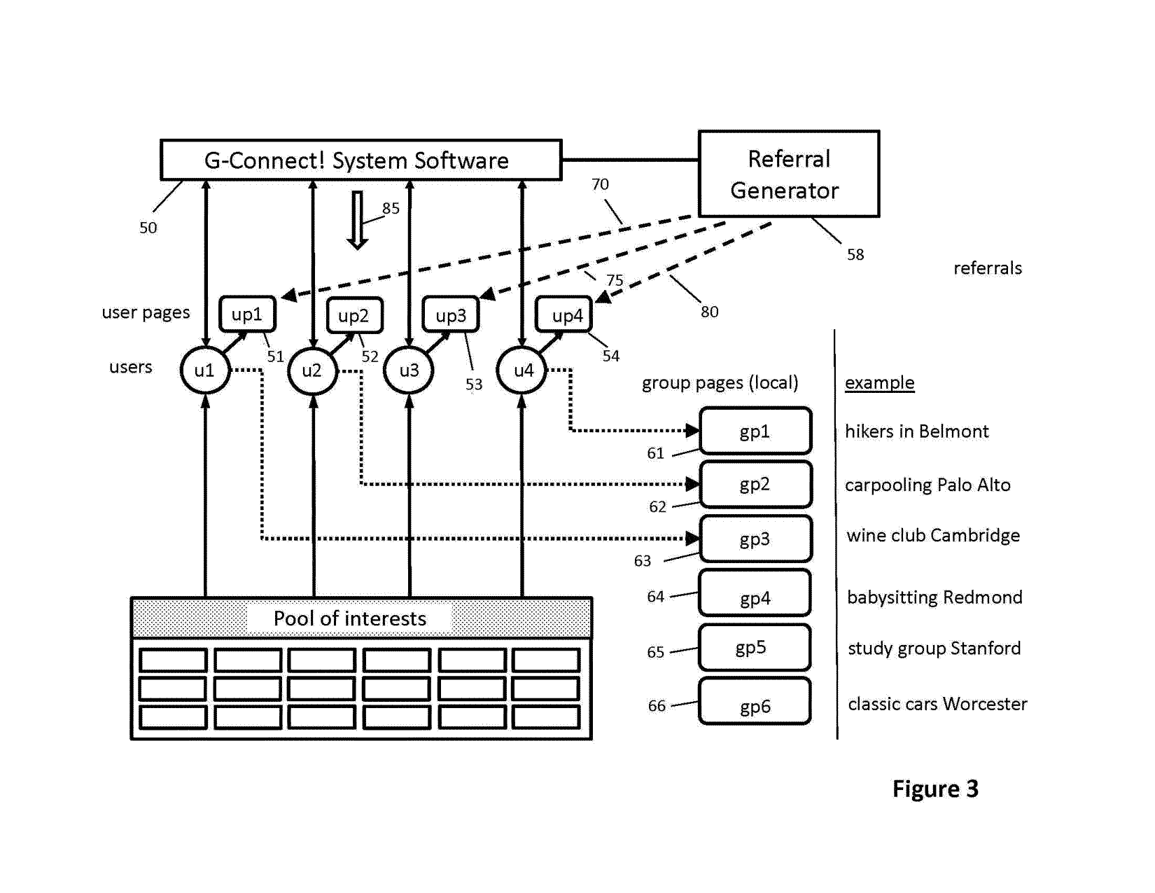

FIG. 3 illustrates further operation of the social network service. The system searches through the user data to find commonality of interests based on the sign-up information provided by the users (stored within a user database), the content of the user pages (such as 51, 52, 53 and 54), the geography of the users and the user preferences. When commonality of interests is found, the system generates a referral (such as 70, 75 and 80), i.e. a message from the system to a user providing contact information and the approximate geographic location of the found interest person or interest group. Typically the system will also provide a link to a group page (such as 61, 62, 63, 64, 65 and 66) or to a personal page (such as 51, 52, 53 and 54). The type of information provided depends on the privacy choices made by the user during registration or as updated at a later point in time.

If the search finds no interest groups for the particular interest defined by the user, the system may invite the user to form a new interest group, and other users looking for a similar interest will be introduced and invited to join the new group. If a new interest group is formed, the system generates a new group page. If the members of the group want to appoint an administrator/page master for the group page, they can do so. If they don't do so, the system will act as group administrator with automatic default administrative policies and procedures.

The ability of the system to generate connections, referrals and new interest groups may be a powerful feature that can grow the system in a viral mode. Network growth is not limited to the actions of people, who may be slow to act, it is also actively initiated, encouraged and facilitated by the computer technology of the system.

FIG. 3 also shows examples of typical group pages created by the system: hikers in Belmont group page 61, carpooling in Palo Alto group page 62, etc. Many interest groups will be location specific, such as “wine club in Cambridge”, for the simple reason that often users will want to interact in person (for instance, meet for wine tasting events, which is facilitated or enabled by having local participants, such as other people from Cambridge, Mass. It is generally unlikely that somebody will fly from Dallas, Tex. to Cambridge, Mass. for such a group event. If the nature of the interest group requires frequent or even daily interaction, a geographic focus can be important. For instance, the group 64 “babysitting in Redmond, Wash.” probably needs local babysitters and a babysitter located in Los Angeles is not a good fit. In some embodiments, much of the group formation and activity may be a local matter. Of course there may be exceptions for certain interests, and each group can define its own policy in that regard and each user can decide what interest groups to join and which ones not to join.

FIG. 3 also shows that the system 50 generated a referral 70 sent by the software module called Referral Generator 58 to user page 51. The owner of that page (user u1) decided to accept the system suggestion and connected with group page 63 (wine club in Cambridge). Similarly, user pages 53 and 54 received suggestions and connected with the suggested group pages. By contrast, user page 53 did not receive any referral, because the search did not find individuals or groups with the same or similar interests. In such a case, the user will receive a system invitation 75 to become the founder of a new interest group. The system will include suggestions how to define and organize the new group to make it more likely that it will generate connections and attract other members.

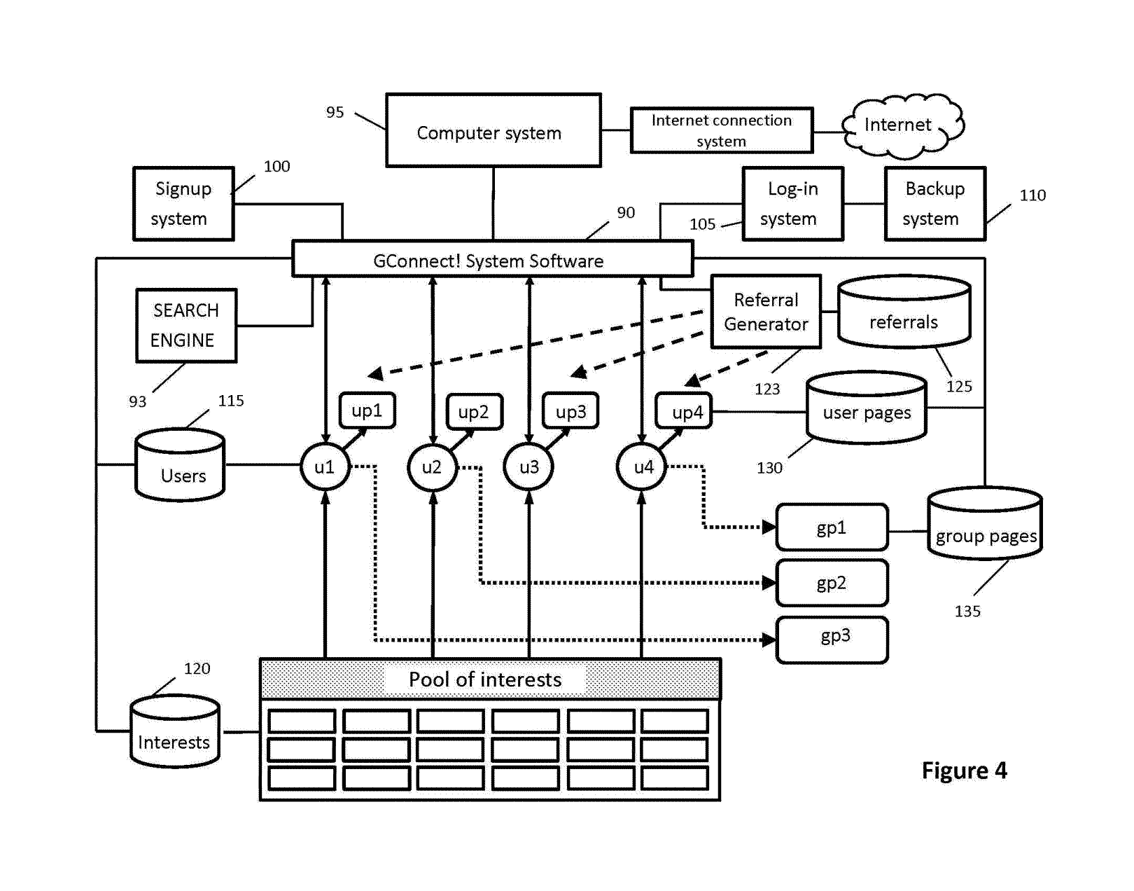

FIG. 4 shows an embodiment of the underlying computer infrastructure for the previously described system of FIG. 3. The system software 90 and the ancillary software modules such as the signup system 100, the log-in system 105 and the backup system 110 reside in the computer system 95. The data resides in several databases, such as the Users Database 115, the Interests Database 120, the Referrals Database 125, the User Pages Database 130 and the Group Pages Database 135. The Search Engine 93 is able to search the databases of the system to find commonality of interests between different users and/or user groups, restrict the search results to the user-specified requirements such as geography (such as for instance proximity to a certain town for a jogging group) and/or other requirements (such as for instance age group for a group of seniors, or status as cancer survivor for a group of cancer survivors, or net worth for a group of investors), and provide information that the system can use to prepare referrals to connect user and/or user groups. The search engine 93 can also incorporate empirical or analytical knowledge of what type of users are a better fit to each other when restricting, sorting and filtering the search results, so as to optimize the referral effectiveness. The Referral Generator 123 is a software module that generates referrals, which are basically messages that are sent to the users to provide them with information to enable them to connect with other users or users groups.

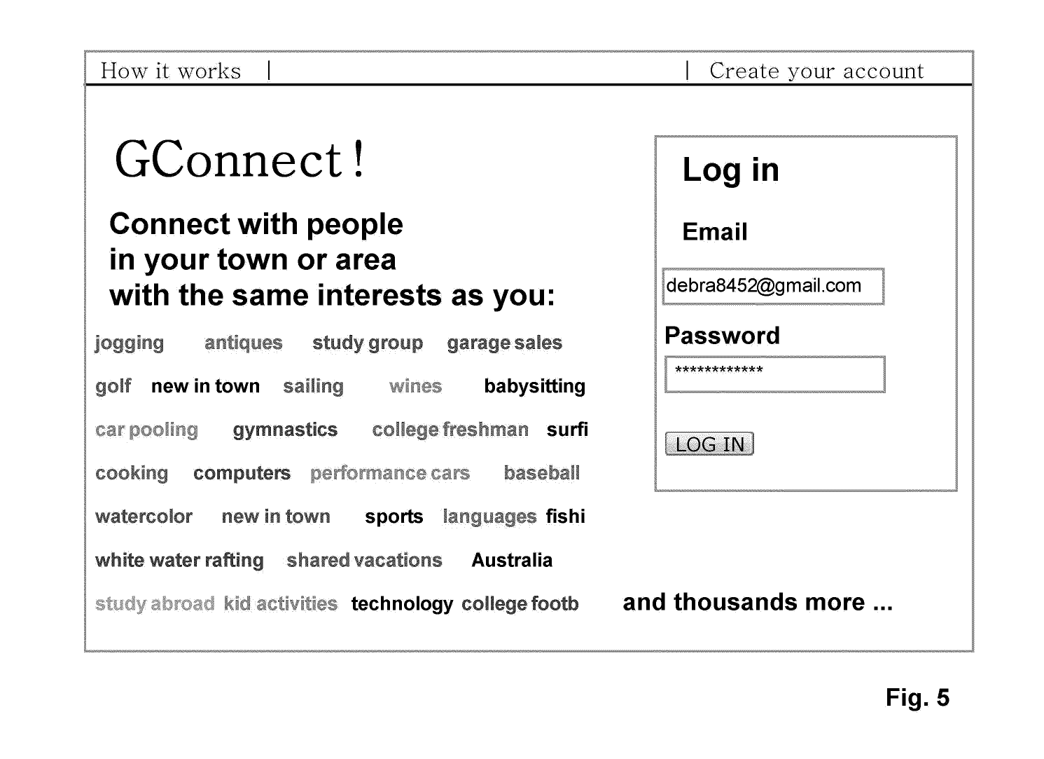

FIG. 5 shows the login page for the GConnect user interface.

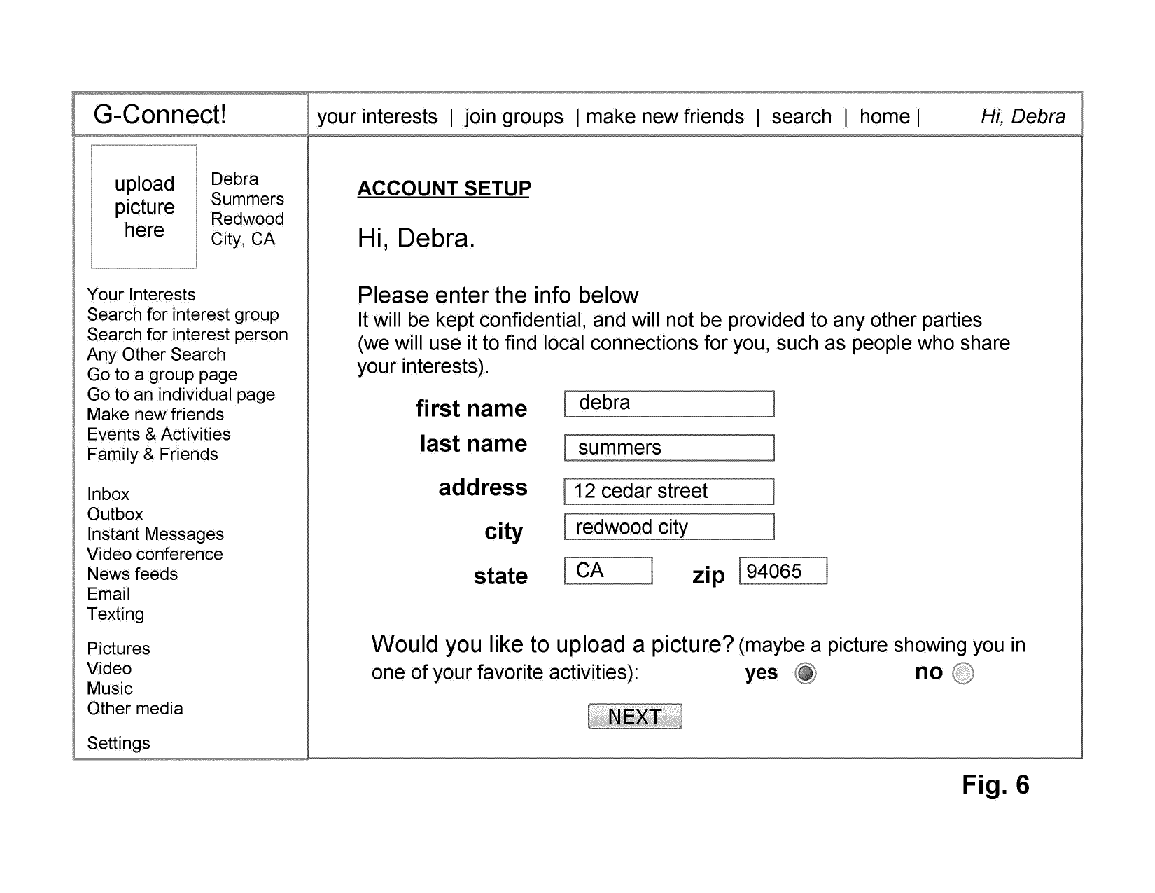

FIG. 6 shows the account setup page which is used by the user to enter basic information including geographical location of the user. That information is important for the system to be able to find other individuals and groups with the same or similar interests within a user-specified distance.

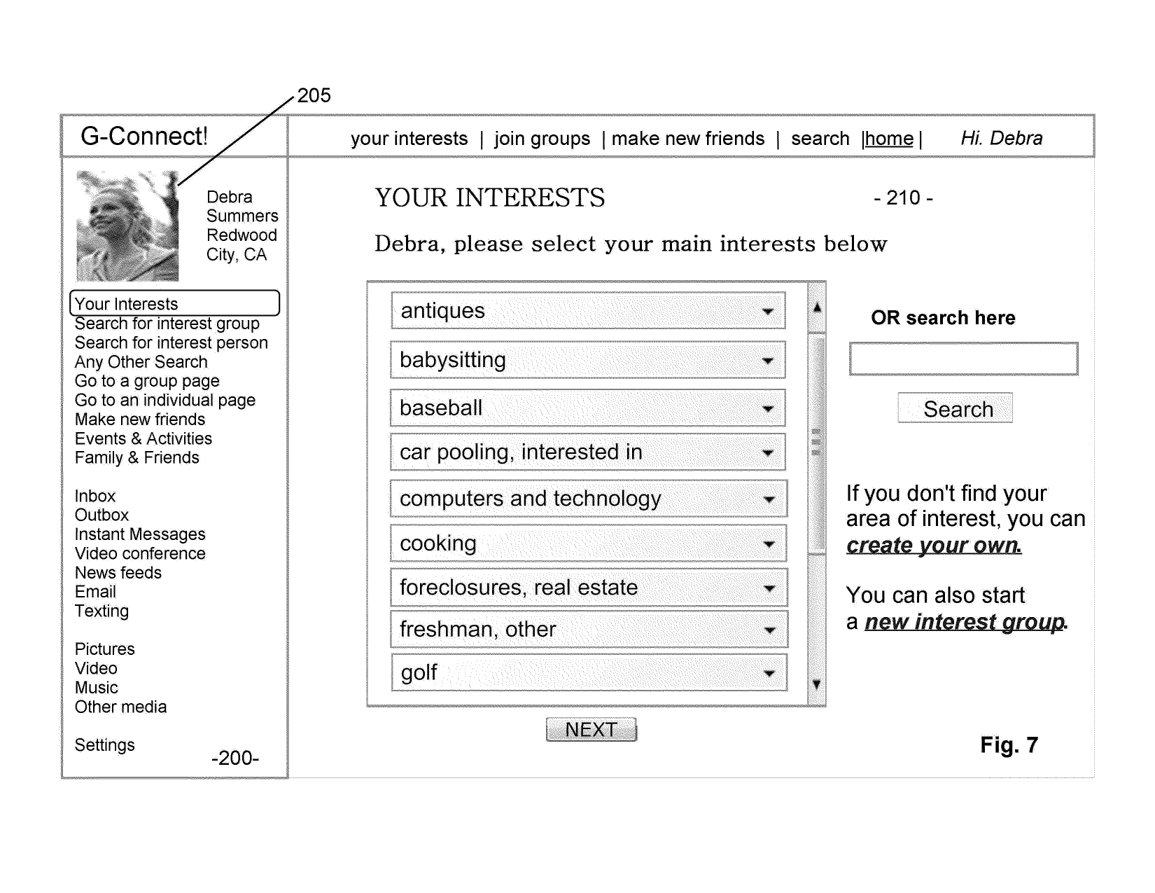

FIG. 7 shows the home page of the system. On the left hand side the vertical toolbar 200 shows at the top a user-provided picture 205 of the user or of an interest or activity. Underneath some of the main tools are accessible via links within toolbar 200:

Your Interests: allows the user to enter interest areas or update previously entered interest areas. This field is highlighted to show that it is the currently active field.

Search for an interest group: this feature allows the user to search for an already existing group based on a common interest, for instance: search for a biking group in a certain location.

Search for an interest person: this feature allows the user to search for another GConnect! user who has an interest in common with him or her, for instance: find somebody to car pool with in South San Francisco.

Any Other Search: this feature allows the user to conduct a variety of other social searches or general searches, such as a Google search.

Go to a group page: this feature allows the user to go to a specific group page. Users can bookmark group pages for easy access in the future.

Go to an individual page: this feature allows the user to go to a specific group page. Users can bookmark individual pages for easy access in the future.

Make new friends: this feature allows the user to connect with other individuals based on user-definable criteria, such as common interest in a hobby, activity or any other criterion, including just for the sake of making friends and socializing (in that case, the interest area can be defined as “talking” or “meeting” or “exchanging ideas”, etc.).

Events & Activities: this feature allows the user to track, schedule, confirm, notify and be notified of any events and activities related to individual connections or group connections made by the user.

Family and friends: this feature allows the user to stay in touch with his already existing contacts with family and friends. This feature can also be used to invite family and friends to join in and participate in a certain interest area, activity or event of any type.

Inbox: allows the user to receive messages from other GConnect! users and groups. The user can also have all his other messages forwarded or copied to this Inbox, including regular emails, instant messages, SMS texting messages, twits, news feeds, etc. The Inbox can be used as a universal inbox by the user, who can basically use it as a universal communications and email client.

Outbox: allows the user to send messages to other GConnect! users and groups, and to anybody in general. The user can also send any other messages (not just GConnect! Messages) and keep a log in this outbox, including regular emails, instant messages, SMS texting messages, twits, news feeds, etc. The Outbox can be used as a universal outbox by the user, who can basically use it as a universal communications and email client.

Pictures, Video, Music, Other Media: allows the user to upload, download, edit and manage all media for his/her own individual page or for a group page.

Settings: allows the user to modify settings, customize the screen, manage privacy settings and set a host of preferences as to how to use the system.

In accordance with selection of the Your Interests link within toolbar 200, the right hand side panel 210 within FIG. 7 under the heading “YOUR INTERESTS” shows a large list of possible interest areas that the user can choose from. It also allows the user to do a search for a particular interest area by using the name of the interest area or related .keywords. If the desired interest does not exist yet in the system database, the user can create it and potentially start a new interest group.

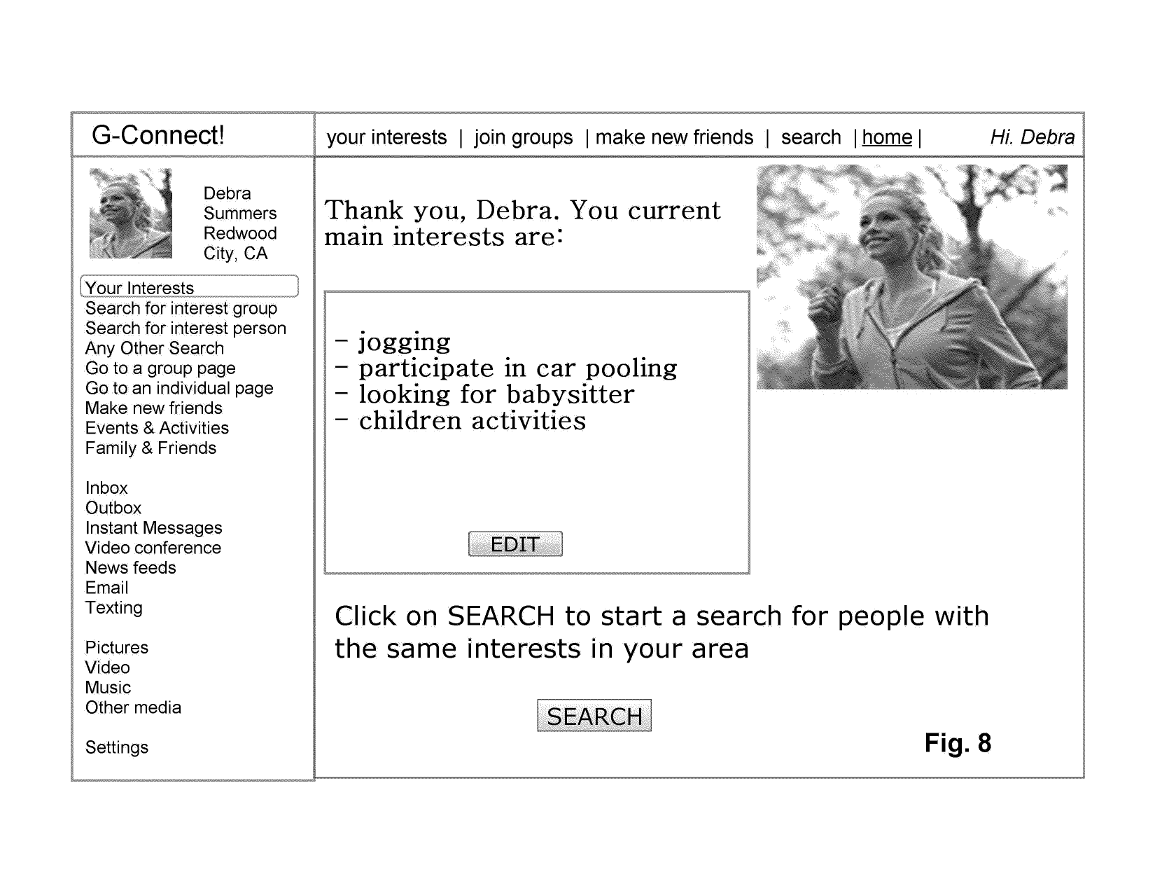

FIG. 8 shows the screen after the user entered her interests. The system displays the list of interests entered and offers the option to edit the list. When the user is satisfied with the list, she can start the SEARCH for other users with common interests.

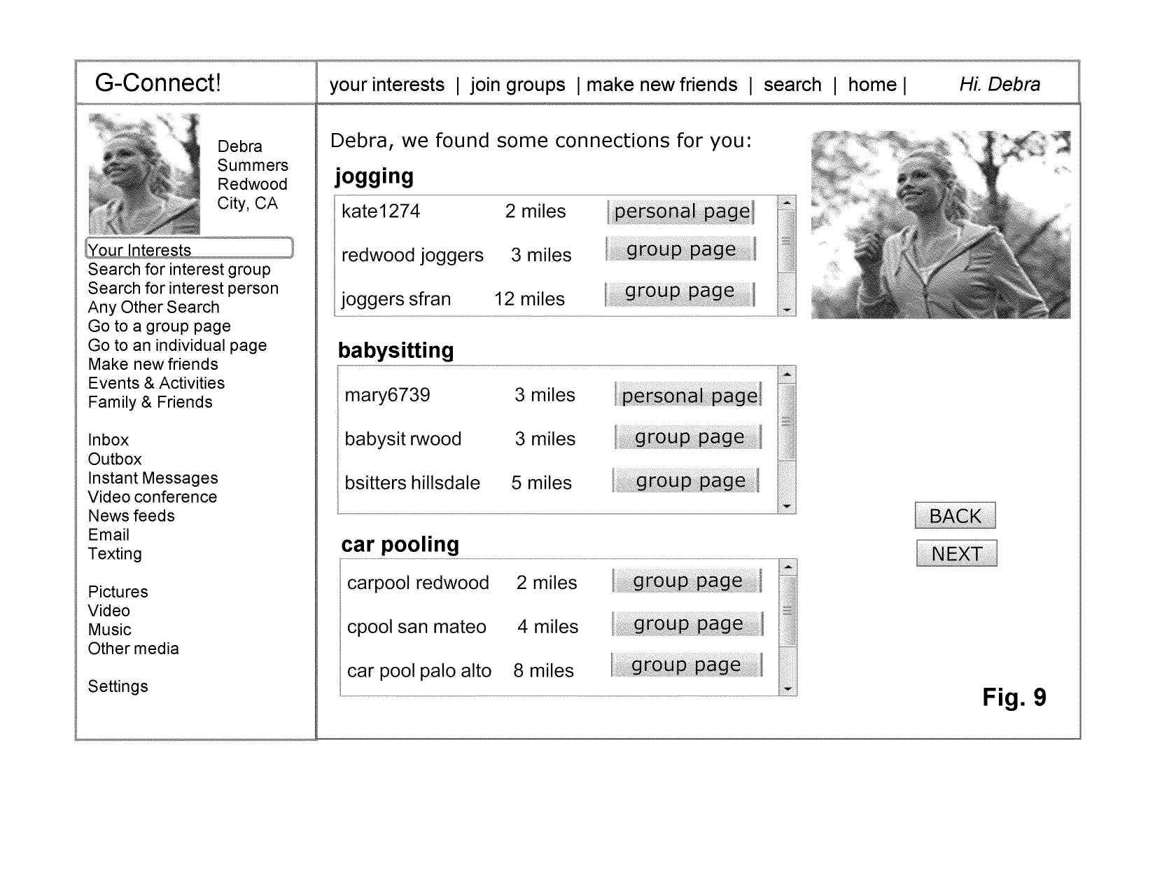

FIG. 9 shows the results of the search for interests in the geographical location specified by the user. Some are individuals, some are groups. In both cases the corresponding contact page is provided.

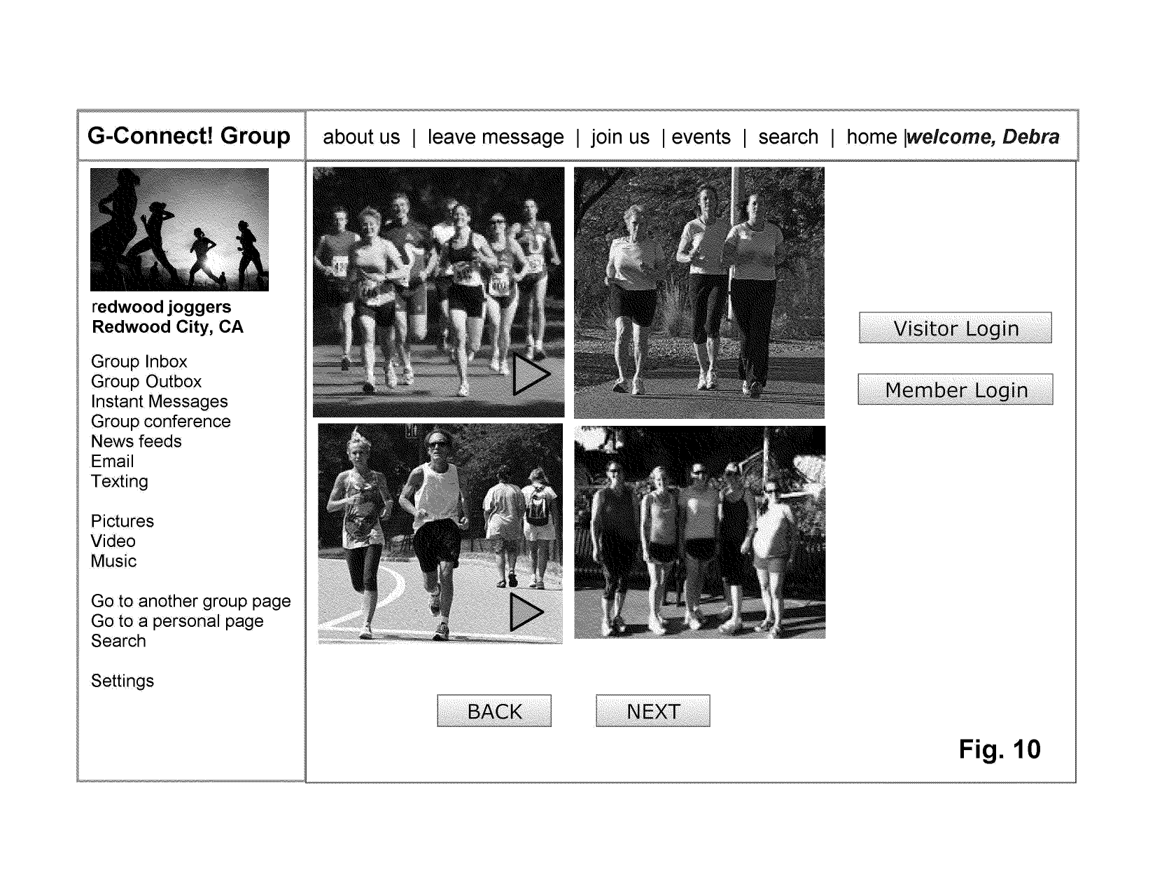

FIG. 10 shows a group page that the user of the previous Figure decided to visit. The page offers some useful functionality to allow a visitor to log in as a visitor and explore the group page as a visitor. The visitor can also submit his/her info to join the group, or can leave a message asking for more info. The page also includes pictures, videos that can give a visitor a good feel for the group is all about.

As described above, social network service embodiments may be provided which facilitate the creation of connections between individuals based on criteria beyond mimicking and expanding upon pre-existing interpersonal relationships, but which also facilitate the creation of new relationships. Embodiments can be better utilized for meeting new people. Meanwhile, system growth can be driven not just by user action, but also by system operation to prompt connections between individuals with compatible interests. Group content and interaction can be facilitated around common interests, while system engagement with events and activity schedules can encourage frequent system use. Meanwhile, system organization around common interests can provide exceptional opportunities for highly focused and well-targeted advertising, such as advertising running footwear to joggers groups.

The foregoing description and drawings merely explain and illustrate the invention and the invention is not limited thereto except insofar as the appended claims are so limited, as those skilled in the art who have the disclosure before them will be able to make modifications and variations therein without departing from the scope of the invention.

What is claimed:

1. A computer-based system for the implementation of a social network service via the Internet, comprising:
a user information database module configured to store information associated with each of a plurality of users of the service;
a groups database module configured to store information associated with one or more groups, each group being associated with one or more users;
an interests database module configured to store information defining one or more interests with which one or more users and/or groups may be associated;
a referral generator module configured to search one or more databases within the system to identify commonality of interests amongst users and/or groups, and generate communications suggesting association of a user with one or more other users or groups.

2. The system of claim 1, wherein the referral generator module is further configured to include user-specified criteria amongst search criteria used to identify commonality of interests amongst users and/or groups.

3. The system of claim 1, wherein the referral generator module is further configured to include criteria associated with a group, to identify users likely to desire association with the group.

4. The system of claim 3, wherein said criteria associated with a group can be determined by one or more users within said group.

5. The system of claim 1, wherein the referral generator module is further configured to include criteria associated with a group, to restrict the identification of users who may be associated with said group.

6. The system of claim 2, in which at least one of the user-specified criteria includes a geographical area with which the user is associated.

7. The system of claim 1, which system further comprises one or more user pages associated with each of said users, said user pages including content derived from said interests database module, said content being determined at least in part by the identification of said interests with which a user is associated.

8. The system of claim 1, further comprising an interests creation module, via which a user or user group can add a new interest to said interests database module.

9. The system of claim 8, further comprising an interests content compliance module configured to evaluate compliance of new interests added via said interests creation module with one or more system policies and content restrictions.

10. The system of claim 1, further comprising one or more group pages accessible by one or more users associated with a group, each of said group pages being associated with one or more interests within said interests database module and containing content populated by members of its associated group.

11. The system of claim 10, wherein the population of content within a group page is controlled by one or more predetermined default system rules.

12. The system of claim 10, wherein the population of content within a group page is controlled by a user designated as a group page administrator.

13. The system of claim 8, in which addition of an interest via said interests creation module automatically triggers the creation of a group page associated with said interest.

14. A computer-implemented method for created connections between users of a social networking service comprising the steps of:
storing within a user database information associated with each of said users during creation of an account corresponding to each user;
maintaining an interests database containing information defining one or more interests with which said users may be associated;
generating a referral communication to a first user suggesting association between the first user and one or more other users based upon analysis of information stored within said user database and said interests database that is associated with said first user and said one or more other users.

15. The method of claim 14, in which said analysis of information stored within said user database and said interests database includes determination that said first user resides within a common geographic region with said one or more other users.

16. The method of claim 15, in which said analysis of information stored within said user database and said interests database further includes determination that said first user and said one or more other users are all associated with one or more of the same interests defined within the interests database.
